(19) United States
(12) Patent Application Publication
(10) Pub. No.: US 2017/0321853 A1
(43) Pub. Date: Nov. 9, 2017

(54) Wire Arrangement for Hand-Reachable USB Charger Related Devices

(71) Applicant: Tseng-Lu Chien, Walnut, CA (US)

(72) Inventor: Tseng-Lu Chien, Walnut, CA (US)

(21) Appl. No.: 15/466,196

(22) Filed: Mar. 22, 2017

Related U.S. Application Data
(63) Continuation-in-part of application No. 14/951,872, filed on Nov. 25, 2015.
Application No. 14/951,872 is a continuation-in-part of application No. 14/829,213, filed on Aug. 18, 2015.
Application No. 14/829,213 is a division of application No. 13/295,562, filed on Nov. 14, 2011.
Application No. 13/295,562 is a continuation-in-part of application No. 12/622,000, filed on Nov. 19, 2009, now Pat. No. 8,434,927.
Application No. 14/829,213 is a continuation-in-part of application No. 14/604,204, filed on Jan. 23, 2015, now Pat. No. 9,196,756.
Application No. 14/604,204 is a continuation of application No. 13/534,281, filed on Jun. 27, 2012, now Pat. No. 8,960,988.
Application No. 13/534,281 is a continuation of application No. 12/710,561, filed on Feb. 23, 2010, now Pat. No. 8,303,158.
Application No. 12/710,561 is a continuation-in-part of application No. 14/870,601, filed on Sep. 30, 2015.
Application No. 14/870,601 is a continuation-in-part of application No. 14/643,026, filed on Mar. 10, 2015.
Application No. 14/643,026 is a continuation of application No. 14/144,703, filed on Dec. 31, 2013.
Application No. 14/144,703 is a continuation of application No. 13/161,643, filed on Jun. 16, 2011, now Pat. No. 8,783,936.
Application No. 13/161,643 is a continuation-in-part of application No. 13/117,227, filed on May 27, 2011.
Application No. 13/117,227 is a continuation-in-part of application No. 13/858,604, filed on Apr. 8, 2013.
Application No. 13/858,604 is a continuation-in-part of application No. 14/875,675, filed on Oct. 5, 2015.
Application No. 14/875,675 is a continuation-in-part of application No. 13/870,253, filed on Apr. 25, 2013, now Pat. No. 9,559,472.
Application No. 13/870,253 is a continuation-in-part of application No. 13/863,073, filed on Apr. 15, 2013.
Application No. 13/863,073 is a continuation-in-part of application No. 14/858,538, filed on Sep. 18, 2015.
Application No. 14/858,538 is a continuation-in-part of application No. 14/793,262, filed on Jul. 7, 2015.
Application No. 14/793,262 is a continuation-in-part of application No. 14/642,169, filed on Mar. 9, 2015.
Application No. 14/642,169 is a continuation of application No. 12/950,017, filed on Nov. 19, 2010, now Pat. No. 8,998,462.

(51) Int. Cl. F21S 8/00; F21V 14/06; F21S 9/02; F21S 10/00; F21V 5/04; F21V 13/02; F21V 14/00; F21V 29/00; F21S 4/28; G02F 1/13; F21V 23/04; F21V 23/00; G03B 23/00; G03B 21/20; F21V 21/22; F21V 21/14; F21V 21/08; F21V 17/02; F21V 14/08; F21V 33/00; F21K 9/232; F21Y 2115/10; F21V 21/29; F21V 21/30; F21W 121/00; F21Y 101/00; G03B 21/14

(52) U.S. Cl. CPC F21S 8/035; F21K 9/232; F21V 14/06; F21S 9/02; F21S 10/002; F21S 10/007; F21V 5/04; F21V 13/02; F21V 14/003; F21V 14/006; F21V 29/00; F21S 4/28; G02F 1/1313; F21V 23/04; F21V 23/00; G03B 23/00; G03B 21/2046; F21V 21/22; F21V 21/14; F21V 21/08; F21V 17/02; F21V 14/08; F21V 33/0052; F21Y 2115/10; F21V 21/29; F21V 21/30; F21V 23/0442; F21V 23/0471; F21W 2121/00; F21Y 2101/00; G03B 21/142; Y10S 362/806; Y10S 362/80

(57) ABSTRACT

A desktop USB-charger related product has space to receive an AC power-wire, USB-charger wire, or another charging related wire(s). The USB-charger related product is arranged to be installed on a desk top at a hand-reachable distance from a user by attachment so that there is no need for the user to bend body or knee in order to charge a device using the charger. The USB-charger related product has at least one USB-port that can supply a desired output-current in the range of from 1.0 A to 12 A and 3.5 VDC to 8.5 VDC by converting input AC power ranging from 110 VAC to 250 VAC. The USB-charger product may also optional to incorporate at least one additional device such as an AC outlet, sensor, motion sensor, remote control, time display, LEDs, other lights, a power fail device, a smell device, an audio device, a video device.

This application is CIP or Division for co-pending filing for (#GGG-10) Filing Series No. 14-951,872 which is CIP filing of US (#GGG-9) Filing Series No. 14-870,601, which is CIP filing of US (#GGG-8) Filing Series No. 14-834,613, which is CIP filing of US (#GGG-7) Filing Series No. 14-834,823, which is CIP filing of US (#GGG-6) Filing Series No. 14-834,557, which is CIP filing of US (#GGG-5-1) Filing Series No. 14-858,538, which is CIP filing of US (#GGG-5) Filing Series No. 14-839,935, which is CIP filing of US (#GGG-4C) Filing Series No. 14-827,810, which is CIP filing of US (#GGG-4) Filing Series No. 14-189,062, which is CIP filing of US (#GGG-3C) Filing Series No. 14-643,026, which is CIP filing of US (#GGG-2C) Filing Series No. 14-548,620, which is CIP filing of US (#GGG-1C) Filing Series No. 14-548,561, which is CIP filing of US (#GGG-3) US Filing Series No. 14-189,062 which is CIP filing of US (#GGG-2) U.S. Pat. No. 8,9119,137, which is CIP filing of US (#GGG-1) U.S. Pat. No. 8,915,608, which is CIP filing of US (#GGG-2011) U.S. Pat. No. 8,783,936 family has all details discussion for the USB charging port features and method to making same.
This filing is Continue of filing of below 2 co-pending filing case (#GGG-2011) U.S. application Ser. No. 13/161,643 filed Jun. 16, 2011 & (#FFF-2011) U.S. application Ser. No. 13/117,227 filed on May 27, 2011.

The current invention is related to the wire arrangement for a USB charger device disclosed in co-pending (#RRR) U.S. patent application Ser. No. 13/858,604, filed Apr. 8, 2013.

The current invention is related to the power station having built-in LED units and a USB charger disclosed in co-pending (#SSS) U.S. patent application Ser. No. 13/863,073, filed on Apr. 15, 2013.

The current invention is related to the power station having built-in LED units and a USB charger disclosed in co-pending (#TTT) U.S. patent application Ser. No. 13/870,253, filed on Apr. 25, 2013 (Now is U.S. Pat. No. 9,559,471).

The current invention is related to the wire arrangement for a USB charger device disclosed in co-pending U.S. patent application Ser. No. 13/858,604, filed Apr. 8, 2013.

The current invention is related to the power station having built-in LED units and a USB charger disclosed in co-pending U.S. patent application Ser. No. 13/863,073, filed Apr. 15, 2013.

### BACKGROUND

According to the current invention, a USB-charger related product includes a wire arrangement for a receiving-means such as a USB-port, outlet receiving socket, LED-unit, or any combination thereof, that enables the USB-charger related product to be located on a desk surface or other hand-reachable location to offer more convenience to people.

The current invention's features include: 1. Hand-reachability, so that there is no need to bend the human body or knee to initiate charging, thereby preventing people from suffering waist or knee injury, which is especially critical for aged people. 2. Provision of a built-in wire arrangement to coil, wrap, roll, store, and/or release an AC power wire or other wires related to a USB charger operation as needed, so that there is no more mess involving AC wires or other wires for charging kits. 3. Desktop installation features such as attachment-means, fixing-means, assembly means, weight means, and/or magnetic means to keep the USB charger related products on a desk top or surface(s) without being moved by the weight of the AC power line or an external force, thereby keeping the products on the desk's surface(s) without drop to the floor. 4. The option of making large but thin products that people will use on a desk top or similar surface without require extra new space for USB Charger related products. 5. A USB charger output-end power min. of from 1.0 Amp up to N-Amp, which is not obtainable from laptop USB ports or other portable or travel USB chargers, thereby reducing the long wait time conventionally required for charging electric or electronic devices. 6. The wire arrangement may be implemented by a roller, retractable means, spring means, or twist means to allow people to keep all charging related wires or AC power wires well stored and not make a mess.

These six features of the current invention offer people convenience for living.

The current invention has subject matter in common with the inventor's U.S. patent application Ser. No. 12/950,017, filed Nov. 29, 2010, which discloses a multiple surface LED light with a rotating device that exposes LED light device(s), USB devices, and outlets devices built into a rotating substrate with more than one surface to offer multiple functions. The current invention also has subject matter in common with the inventor's U.S. patent application Ser. No. 11/806,285, filed May 31, 2007, which discloses a multiple function LED light device, and the inventor's U.S. Pat. No. 7,318,652, which is directed to a multiple function wall cover, as well as the inventor's U.S. Pat. Nos. 7,651,365 and 7,810,985. All of these patented or pending cases relate to a light source with outlets devices to which the wire arrangement of the current invention may be applied.

Also by the current inventor are U.S. patent application Ser. No. 13/161,643, filed Jun. 16, 2011, directed to a desk top item with LED means and USB-unit(s) or USB-module(s) to charge other electric or digital-data devices and Ser. No. 13/117,227, filed May 27, 2011, directed to a universal module having USB-unit(s) and/or outlet-unit(s) for a variety of electric or digital-data devices.

The current invention differs from the arrangements disclosed in U.S. prior art at least in the follow respects:

U.S. Pat. No. 7,736,033 (Bhart) discloses a lamp base with an electric device recharge receptacle, and in particular an outlet device and a cigarette lighter built on a lamp base.

The lamp base includes circuitry that transforms an input AC current into a 12V DC automobile current, output, and further includes a plug-in device that transforms the input 12 VDC current into USB end current (5 Volt). This means that Bhart's device at least needs two expensive circuits/transformers to transform the input 120 VAC wall outlets power supply into a USB 5VDC output. This is not economical and nobody needs a 12 VDC output for household use. In contrast, the present invention directly transforms an input-end 120 VAC into an output-end 5 VDC, which is more practical than the arrangement disclosed by Bhart.

U.S. Patent Publication No. 2011-017703 discloses a rotatable and concealable device which only has an outlet device with manual switch. The input 120 VAC power source is connected directly through a metal piece to deliver 120 VAC to the rotatable & concealable device's receptacles to offer 120 VAC current when another device is plugged into the receptacle. The '703 publication fails to disclose any USB charger concept, circuit, design and application, and so is not related to the current invention.

U.S. Pat. No. 7,897,277 (Meyer et al.) discloses a reversible battery cartridge which is used to provide backup power for all kinds of lamp and mainly for power fail application. This has nothing to do with USB ports and USB charger applications, and therefore is totally different from the current invention, which is related to a device having (1) USB ports+(2) USB charging+(3) an outlet supply power source+(4) an LED light and universal lamp base to fit for all kinds of existing lamp bases so as not to occupy any new desk top space because (5) the universal desk base overlays a top of the existing lamp base. Furthermore, the current invention has (6) an LED light incorporated with the above-listed features (1) (2) (3) (4) and (5), so that it becomes a unique practical universal power station, especially because (7) the current invention can be arranged to not only supply one kind of power to a charger, but also can supply different types of power to different electric or digital-data device(s).

U.S. Pat. No. 6,474,823 discloses a laptop computer with a top illumination light. The computer uses a transformer to converting input AC power into 5 Volt DC current for internal use. However, there is no USB charger circuit inside the computer. Instead, the computer's external transformer directly delivers 5 VDC current to the USB port, so the computer system of this patent differs from the charger products of the current invention, which uses an internal USB charger circuit to convert 120 VAC into a 5 VDC USB charging output. As disclosed in this patent, the computer itself has an input-end current of 5 VDC and output-end current at the USB ports that is also 5 VDC, so there is no need for a USB charger circuit inside.

U.S. Pat. No. 8,529,289 U.S. application Ser. No. 13/568,833 filed on Aug. 7, 2012 and U.S. Pat. No. 9,028,274 U.S. application Ser. No. 13/962,627 filed on Aug. 8, 2013 Quirky shown the outlet device has transforming shape and construction is much later than current invention inventor's earlier and still pending case (#UU-2010) U.S. application Ser. No. 12,938,628 fi1ed on Nov. 3, 2010 has both the transforming construction for outlet from T-shape to I-shape. The also, The (#FFF) co-pending filing U.S. application Ser. No. 13/17,227 Filed on May 27, 2011 also disclosure the USB and Outlet device on wall mounted device. Furthermore, The (#RR-2010) U.S. application Ser. No. 12/887,709 Filed on Sep. 22, 2010, And (#HHH-2011) U.S. application Ser. No. 13/162,284 Filed on Jun. 17, 2011, and (#T-1-2010) U.S. application Ser. No. 12/894,865 Filed on Sep. 30, 2010, and (#V-2008) U.S. application Ser. No. 12/003,691 Filed on Dec. 31, 2007, and (#III) U.S. application Ser. No. 13/296,469 Filed on Nov. 15, 2011, and (#JJJ-2011) U.S. application Ser. No. 13/296,508 Filed on Nov. 15, 2011, and (#KKK-2011) U.S. application Ser. No. 13/295,307 Filed on Nov. 15, 2011, and (#Z-2008) U.S. application Ser. No. 12/149,963 Filed on May 12, 2008. All these co-inventor co-pending or earlier filed cases still pending so all these concept for USB Charger, Power station, Transforming outlet or-and USB unit should be still fall within the current filing and parent claims. The Qirky any later filed cases should become invalid for copy the current co-inventor parent filing spirits.

Further, The current filing case is CIP of the Above list for (#GGG) family for desktop USB applications only difference is current invention has all the Wire arrangements and lack of the LED light install on arms or stand or pole which let people can have higher level of light source. The current invention also lack of the audio related functions.

Because of the above-described differences, the current invention has at least the following advantages: A. It offers the most convenient way to use USB ports and/or other power outlets and LED units on a desk surface within a hand-reachable distance. The current invention allows all power stations or products to be installed on the desk top very steadily and overcome the super heavy duty of the power cord, which extends from the wall outlet to the power station or product and exerts a pulling force as a result of the cord's weight. The normal design for all marketed extension cords with built-in outlets or additional features such as USB ports, audio-ports, video-ports, internet-ports, or other electric's ports is not capable of being put on a desk top because the power-cord's weight is way too heavy if the outlet's power cords meet safety authorities' requirement that power cords use 10, 12, 14, or 16 gauge wire. Such a very heavy duty cord, which may have different lengths of from 1 foot to 100 feet is impossible to install on a desk top. Furthermore, such a conventional outlet device does not really need to be put on a desk top because there are too few occasions to plug or unplug the plugs of electric or electronic devices into or from the outlet device. However, the current invention has built-in USB ports or LED light devices, for which there is a need to connect to the USB-ports or turn on-off the said LED unit(s) many times per day or at least once a day because of the many devices, such as cellphones, mobile phones, smartphones, I-Pads, and panel communication or consumer computer devices that need to be charged from USB ports. The current invention offer the most continent to put the USB-ports and LED units on the desk top to prevent from people bend the body and knee down to connect the grounded multiple function extension cord or wall mounted USB ports, The current invention offers the most convenient way for people to get power from built-in outlets or USB ports and also provide functions of built-in LED units just on a desk top. This is a major concept for the current invention. B. The current invention offers a simple way to install a power station or products on a desk surface so that there is no need for people to bend their body or knee to a lower position in order to obtain charging and prevent injury or damage to the human waist and knee. C. The power station of the invention can be adapted to include the unique features described in the inventor's copending U.S. patent filings in order to supply power to charge the majority of electric, digital-data, audio, video, or internet devices on a desk top without the need to frequently bend the body to or near the ground when connecting to an outlet or USB port, or making use of an LED unit.

The current invention may also be applied to the following:

(A) a rotating LED light device having outlets or electric receiving sockets as disclosed in copending U.S. patent application Ser. No. 12/950,017, filed Nov. 19, 2010;

(B) an electrical device having a built-in universal USB-unit(s) and outlet-unit(s), as disclosed in copending U.S. patent application Ser. No. 13/117,227, filed May 27, 2011;

(C) a desk top LED device having a USB-unit(s) or outlet-unit(s) to charge an electric or digital device, as disclosed in copending U.S. patent application Ser. No. 13/161,643, filed Jun. 16, 2011; and

(D) a multiple function LED night light as disclosed in U.S. patent application Ser. No. 11/806,285, filed May 31, 2007.

The current invention may also use the following concepts described in the following LED-related filing cases of the inventor: (1) a project light, (2) more than one function, (3) adjustable focus, (4) adjustable angle, (5) elastic contact points, (6) an LED heat solution, (7) heat sensitive parts installation, and (8) extend means, disclosed in the inventor's U.S. patent application Ser. Nos. 13/367,758; 13/367,687; 13/296,508; 13/295,301; 13/021,107; 12/950,017; 12/938,564; 12/886,832; 12/876,507; 12/771,003; 13/021,124; 12/624,621; 12/622,000; 12/318,470; 12/914,584; 12/834,435; 12/292,153; 12/907,443; 12/232,505; 11/806,711; and 11/806,285.

The current invention also has subject matter in common with the inventor's U.S. patent application Ser. No. 13/295,301 (“The Device has built-in Digital Data means and Powered by unlimited power source of light device”); Ser. No. 13/296,508 (“The Device has built-in Digital Data means and power unlimited power source of LED Bulb”); Ser. No. 13/296,460 (“The device has built-in Digital data means and powered by unlimited power source of Lamp Holder”); Ser. No. 12/951,501 (“Lamp Holder has built-in LED Night light”); Ser. No. 12/950,017 (“Multiple surface LED light”); Ser. No. 13/162,824 (“Light device with display means has track-means and removable LED-unit(s)”); Ser. No. 12/938,628 (“LED light fixture has outlet(s) and removable LED unit(s)”); Ser. No. 12/887,700 (“Light fixture with self-power removable LED unit(s)”); Ser. No. 12/149,963 (now U.S. Pat. No. 7,722,230); Ser. No. 12/073,095 (now U.S. Pat. No. 7,726,869); Ser. Nos. 12/073,889; 12/007,076 (now U.S. Pat. No. 7,726,841); Ser. No. 12/003,691 (now U.S. Pat. No. 7,726,839), and Ser. No. 12/894,865.

In addition to the above, light device related patent applications of the inventor include U.S. patent application Ser. Nos. 13/295,301, 13/296,469, 12/624,621, 12/622,100, 12/318,471, 12/318,470, 12/318,473, 12/292,153, 12/232,505, 12/232,035, 12/149,963, 12/149,964, 12/073,095, 12/073,889, 12/007,076, 12/003,691, 12/003,809, 11/806,711, 11/806,285, 11/806,284, 11/566,322, 11/527,628, 11/527,629, 11/498,874, 12/545,992, 12/806,711, 12/806,285, 12/806,284, 12/566,322, 12/527,628, 12/527,629, 12/527,631, 12/502,661, 11/498,881, 11/255,981, 11/184,771, 11/152,063, 11/094,215, 11/092,742, 11/092,741, 11/094,156, 11/094,155, 10/954,189, 10/902,123, 10/883,719, 10/883,747, 10/341,519, 12/545,992, 12/292,580, 12/710,918, 12/624,621, 12/622,000, 12/318,471, 12/318,470, 12/318,473, 12/292,153, 12/710,561, 12/710,918, 12/711,456, and 12/771,003.

The relevance of the following U.S. patent applications of the inventor can be understood from the titles listed in parentheses: Ser. No. 13/295,301 (“Device has built-in digital data means and powered by unlimited power source for Lamp holder”); Ser. No. 13/296,469 (“Device has built-in digital data means and powered by unlimited power source for light Device”); Ser. No. 12/951,501 (“Lamp Holder has built-in LED light”); Ser. No. 12/771,003 (“LED light has geometric-unit(s) incorporated project means”); Ser. No. 12/711,456 (“LED power failure Light”); Ser. No. 12/710,561 (“LED light device has special effects”); Ser. No. 12/710,918 (“LED light device has more than 1 reflective means for plurality of image”); Ser. No. 12/624,621 (“projection device or assembly for variety of LED light”); Ser. No. 12/622,000 (“Interchangeable Universal Kits for all LED light”); Ser. No. 12/318,471 (“LED night light with pinhole imaging”); Ser. No. 12/318,470 (“LED night light with Projection features”); Ser. No. 12/318,473 (“LED night light with laser or hologram element”); Ser. No. 12/292,153 (“LED night light with Projection or imaging features”); Ser. No. 12/232,505 (“LED night light with Projection features”); Ser. No. 12/149,963 (“Removable LED light device”) [Ser. No. 12/149,964 (“Surface Mounted device with LED light”); Ser. No. 12/073,095 (“LED Track light device”); Ser. No. 12/073,889 (“LED light with changeable position with Preferable power source”) [Ser. No. 12/007,076 (“LED light with changeable geometric system”); Ser. No. 12/003,691 (“LED light with changeable geometric dimension features”); Ser. No. 12/003,809 (“LED light with changeable features”); Ser. No. 11/806,711 (“Multiple LED light with adjustable angle features”); Ser. No. 11/806,285 (“LED Night light with outlet device”); Ser. No. 11/806,284 (“LED Night light with more than 1 optics means”); Ser. No. 11/527,628 (“Multiple function Night light with air freshener”); Ser. No. 11/527,629 (“LED Night light with interchangeable display unit”); Ser. No. 11/498,874 (“Area illumination Night light”); Ser. No. 11/527,631 (“LED Time piece night light”); Ser. No. 12/545,992 (“LED time piece Night light”); Ser. No. 12/292,580 (“LED Time Piece Night light”) Ser. No. 11/498,881 (“Poly Night light”); Ser. No. 11/255,981 (“Multiple light source Night Light”); Ser. No. 11/184,771 (“Light Device with EL elements”); Ser. No. 11/152,063 (“Outlet adaptor with EL”); Ser. No. 11/094,215 (“LED night light with liquid medium”); Ser. No. 11/094,215 (“LED Night light with Liquid optics medium”); Ser. No. 11/092,741 (“Night light with fiber optics”); Ser. No. 10/883,747 (“Fiber Optic light kits for footwear”); Ser. No. 11/498,874 (“Area Illumination for LED night light”); Ser. No. 11/527,629 (“Time Piece with LED night light”); Ser. No. 11/527,628 (“Multiple Function Night light with Air Freshener”); Ser. No. 11/806,284 (“LED Night light with more than one optics mediums”); Ser. No. 11/806,285 (“LED Night Light with multiple function”); and Ser. No. 11/806,711 (“Multiple LEDs Light with adjustable angle function”).

The inclusion of any of the features disclosed in the above-listed patents filings of the inventor may still fall within the scope of the current invention and all related equivalent functions or replacement parts also should fall within the current invention's scope.

The current invention relates to a wire arrangement for hand-reachable desktop “USB charger related products.” The term USB charger related products in turn relates to products that at least have one USB charger with its receiving-means and any combination of additional market-available electric or electronic parts and accessories to form a single or plurality of function(s) device that can be placed on a desktop to offer people convenience without bending the body or knee to connect a device for charging.

### BRIEF DESCRIPTION OF THE DRAWINGS

FIGS. 1, 3B, and 3D are isometric views of a first preferred embodiment of the invention, which includes a wire arrangement for USB-charger related products.

FIG. 2 includes isometric views of second and third preferred embodiments of the invention, which includes a wire arrangement for a hand-reachable USB charger device.

FIGS. 3A and 3C are end views of the embodiment of FIGS. 1, 3B, and 3D.

FIG. 4 is an isometric view of a fourth preferred embodiment, which includes a wire arrangement for a hand-reachable USB charger device embodiment that only has a built-in USB charger without other combination items such as outlets, an LED unit, or electric parts and accessories for carrying out other functions.

FIGS. 5, 5A-5C, 6, and 6A-6B are isometric views of a fifth preferred embodiment of the invention, which includes construction parts to form a space, gap, or dimension to allow application of simple physics and mechanical theory to arrange a wire by twisting a top cover to wind or release the wire when people sit at the desk and charge their other electric devices by a hand-reachable USB charger or outlet, the wire arrangement being situated on the bottom of the USB charger related unit or product using an overlay so that there is no need to take up any extra space on the desktop.

FIG. 7 and FIG. 7A are isometric views of a sixth preferred embodiment which has a twister-means that uses a rotatable top cover to coil or release a wire to or from a space, gap, room, or compartment in the wire arrangement, the wire having a predetermined desired wire length and wire gauge.

FIGS. 8A-8C, 9A-9E, 10A-10B, 11A-11B, and 12A-12B are isometric views of a different USB charger and USB Charger related products having a built-in wire arrangement, the USB charger related products incorporating at least one device selected from a USB charger device, outlet device(s), LED light device(s), time piece device(s), motion sensor device(s), remote control device(s), smell device(s), motion device(s), animation device(s), audio device(s), video device(s), Internet device(s), digital data device(s) or other electric or electronic device(s) available from marketplace to provide a more-than-one-function product.

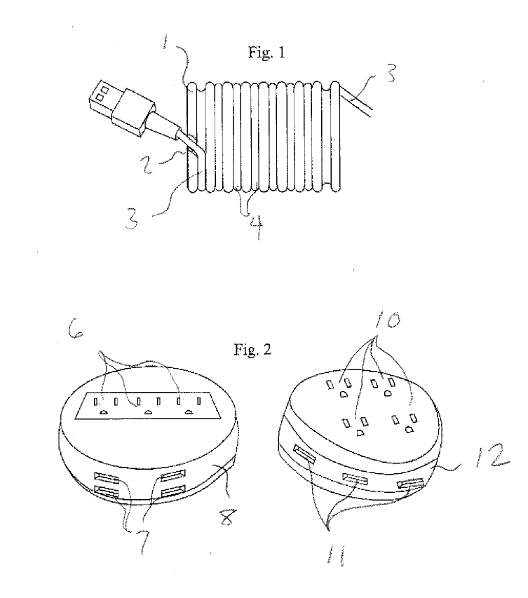

While FIGS. 1 to 12 show concepts of the current invention, it will be appreciated that any similar concept or equivalent application with a same purpose or that is based on a same physics theory or knowledge may still fall within the invention's scope or claim coverage.

### DETAILED DESCRIPTION OF THE PREFERRED EMBODIMENTS

Basing This application is CIP or Division for co-pending filing for (#GGG-10) Filing Series No. 14-951,872 which is CIP filing of US (#GGG-9) Filing Series No. 14-870,601, which is CIP filing of US (#GGG-8) Filing Series No. 14-834,613, which is CIP filing of US (#GGG-7) Filing Series No. 14-834,823, which is CIP filing of US (#GGG-6) Filing Series No. 14-834,557, which is CIP filing of US (#GGG-5-1) Filing Series No. 14-858,538, which is CIP filing of US (#GGG-5) Filing Series No. 14-839,935, which is CIP filing of US (#GGG-4C) Filing Series No. 14-827,810, which is CIP filing of US (#GGG-4) Filing Series No. 14-189,062, which is CIP filing of US (#GGG-3C) Filing Series No. 14-643,026, which is CIP filing of US (#GGG-2C) Filing Series No. 14-548,620, which is CIP filing of US (#GGG-1C) Filing Series No. 14-548,561, which is CIP filing of US (#GGG-3) US Filing Series No. 14-189,062 which is CIP filing of US (#GGG-2) U.S. Pat. No. 8,9119,137, which is CIP filing of US (#GGG-1) U.S. Pat. No. 8,915,608, which is CIP filing of US (#GGG-2011) U.S. Pat. No. 8,783,936 family has all details discussion for the USB charging port features and method to making same.
This filing is Continue of filing of below 2 co-pending filing case (#GGG-2011) U.S. application Ser. No. 13/161,643 filed Jun. 16, 2011 & (#FFF-2011) U.S. application Ser. No. 13/117,227 filed on May 27, 2011.

The current invention is related to the wire arrangement for a USB charger device disclosed in co-pending (#RRR) U.S. patent application Ser. No. 13/858,604, filed Apr. 8, 2013.

The current invention is related to the power station having built-in LED units and a USB charger disclosed in co-pending (#SSS) U.S. patent application Ser. No. 13/863,073, filed on Apr. 15, 2013.

The current invention is related to the power station having built-in LED units and a USB charger disclosed in co-pending (#TTT) U.S. patent application Ser. No. 13/870,253, filed on Apr. 25, 2013 (Now is U.S. Pat. No. 9,559,471).

The current invention is related to the wire arrangement for a USB charger device disclosed in co-pending U.S. patent application Ser. No. 13/858,604, filed Apr. 8, 2013.

The current invention is related to the power station having built-in LED units and a USB charger disclosed in co-pending U.S. patent application Ser. No. 13/863,073, filed Apr. 15, 2013.

From above list the (# GGG) and (#FFF) and (#RRR) and (#SSS) and (#TTT) these co-pending and earlier filed parent filing cases, already had very details description for how to work for the USB Outlet and Outlet device. It appreciated all the co-pending or earlier filed family filed cases all the concept, text, drawing, spirits, claims, drawing, illustration should still fall within the current invention and co-pending and patents claims scopes.

Further, the current invention also related to the outlets incorporate with USB port so all the above listed (#HHH-2011) (#RR-2010) and others earlier and still pending case (#UU-2010) should be still be treated as parent filing case and this invention should be continuously filing case for above list (#UU-2010) (#RR-2010) (#HHH-2011).

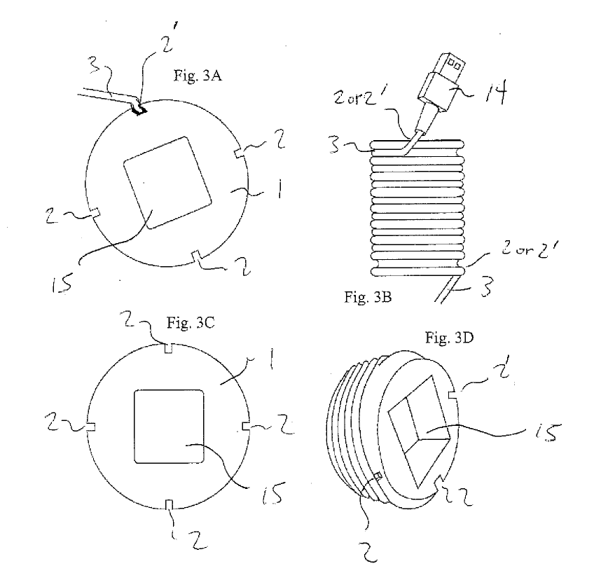

FIG. 1 shows a wire arrangement for a USB charger having at least one hold-means 1 with cut-outs 2, as illustrated in greater detail in FIGS. 3A to 3D. In this arrangement, a wire 3 is positioned in a continuous groove 4 and exits the arrangement through cut-outs 2.

The desk top USB charger may include any combination of a USB-charger(s), outlet(s), LED-unit(s), sensor means, switch means, remote-means(s), motion means, and/or other electric device(s).

FIG. 2 shows a USB charger having 3 AC outlets 6 side-by-side and 2 sets of 2 USB charging ports 2 with a wire arrangement means inside the base 8 to be installed on a desk's surface(s) at a hand-reachable location(s).

FIG. 2 also shows a second embodiment having 4 outlets 10 and 3 USB-charging ports 11 with a wire-arrangement in the base 8 to adjust the wire length as needed from the base to power source, so that even heavy gauge wire will not make a mess when installed on the desk surface, so people can connect equipment with a charger or power source without the need to bend the body because the charger or power source is on the desk top at a hand-reachable location that is most convenient rather than at a lower location or on the floor, which will harm an aged person's waist and knee to cause thousands or hundreds of thousands of dollars for medical surgery.

As shown in FIGS. 3A, 3B, 3C, and 3C, at least one of the output openings or cut-outs 2 for the wire 3 can be cut-out at an angle, as indicated by reference numeral 2′ in FIGS. 3A, 3B, and 3D, so that the wire will not be bent at too great an angle and thereby prevent damage to the wire's inner conductive means. The angle for the cut-outs can each be 60 degrees or 30 degrees depending on requirements. The cut-outs can extend from the edge to inner walls so as to let people hold the wire at any location along a continuous groove, ditch, or channel at any near-by cut-out location.

As shown in FIG. 3B, the walls can have any number of cut-outs 2 or 2′ at the output-end at any location along the continuous groove, ditch, channel, or gaps 4 to allow the wire to come out at any location preferred by people. The narrow cutout's output-end can tightly hold a USB wire with a desired angle so that no harm occurs to the USB wire. The FIG. 3-2 shows only the USB-plug 14 of the USB wire, the other end being connected to a device such as an iPhone, HTC phone, Samsung phone, China mobile phone, flat-panel device, computer device, audio device, video device, or any other USB chargeable device. The ditch, groove, or channel 4 is preferably a continuous arrangement so that sections of the wire 3 do not overlay each other. If the wire arrangement means is not a continuous design, the wire will overlay or underlay when people coil it. However, this overlay or underlay will still fall within the current invention scope. In addition, the wire arrangement means can be made of a soft gel, in which case it can be fitted over a USB-charger so that the charger is positioned with a central compartment 15 within the wire arrangement, and the continuous groove 4 and cutouts 2 or 2′ can be dimensioned to tightly hold the wire in place.

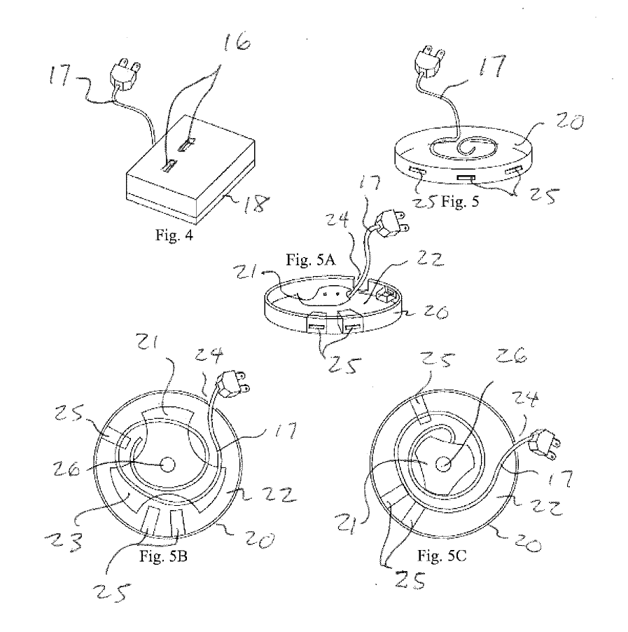

FIG. 4 shows a device having only 2 USB ports 16 without an AC power source outlet(s) so that only a small AC power input wire 17 is needed to supply power to the USB-charger. This kind of USB charger may be installed on a desktop or other surface at a hand-reachable location using traditional attachment-means 18 such as glue, double sided tape, Velcro tape, catches, hooks, screws, a suction cup, magnetic-means, catch-means, hold-means, heavy-means, catch-holder means, or any other attachment-means or fixing-means to enable easy use of the USB charger very often. When the USB-charger has a built-in AC power source outlet, it has to use heavy duty electric-cord such as #14 gauge and very good means to hold the USB-charger and outlets on the desk top or other surface so as to overcome the very heavy weight of the #14-gauge wire. The wire arrangement means has parts and accessories to hold, store, coil, receive, release, pull, twist, extend, fold, and/or retract a wire by a spring, elastic, roller, or rotating means to cause the wire to be well arranged to achieve pre-designed requirements, performance, functions, or effects.

FIG. 5 shows an arrangement with 3 USB ports in a flat and thin USB-charger device, the AC power input wire 17 being coiled or wrapped under the bottom of the round flat and thin USB charger unit. The round flat and thin unit can be put under base of another existing desk-top device, such as a desk-lamp base, coffee cup base, coffee machine base, ashtray base, beverage cup base, phone base, calculator base, medicine bottle base, or other bottle or container base so that the round flat and thin USB charger will not occupy a new space to take away from the limited desk top space. The wire can be coiled or wrapped under the USB-charger unit base, within the housing, or within the walls as described below. The wire arrangement means may have parts and accessories to hold store, coil, receive, release, pull, twist, extend, fold, or retract the wire by a spring, elastic, roller or rotating means to cause the wire or receiving-end(s) of the wire to be well arranged for use in connection with pre-designed requirements, performances, functions, or effects. Since the USB-charger related products do not have AC outlets, LED-units, or other electric function devices built-in, the input AC power wire can be smaller than required for an AC power outlet device.

As shown in FIG. 5A, a preferred wire arrangement means may be designed to include a round and thin housing 20 with USB ports 25 with a central island-shaped wire arrangement mechanism 21, which can easily coil or wrap the wire within a space, gap room, or compartment 22. The island-shaped wire arrangement mechanism includes a cover 23 to stop the wire from falling out from the space, gap, room, or compartment 22. The island-shaped wire arrangement mechanism allows the wire's length to easily be seen when the wire is inside the space. The output-end of the wire arrangement means has a cutout 24 so as to enable the flat and thin USB-charger unit to be installed on any surface.

The USB charger or USB-charger with built-in outlet(s) or USB-charger with built-in outlet(s) and another function device(s) may be round or have any desired geometric shape without departing from the scope of the current invention. Because the USB-charger related products of FIG. 5A only has USB ports 25 without other outlets, LED-units, or other electric function devices, the built-in AC input power wire can be smaller than required for a device with AC output power requirements.

As shown in FIG. 5B, the wire arrangement means on the bottom of unit includes a center pole 26 around which the wire is coiled or wrapped, and a built-in island-shaped mechanism's cover 23 to stop wire 17 from falling from base. A wire output-end with cut-outs has a hold-function to hold the wire in position. The wire arrangement may also have a built-in heavy weight, suction cup, magnetic means, double sided foam tape, Velcro tape, screw, base, or other attachment or fixing-means to secure the round flat and thin USB charger unit in a position without being moved and make a nice and neat wire arrangement from an AC power source to supply a desired current from 1.0 A up to 12 A or more from the USB-ports 25, which is not possible to obtain from any existing device such as a laptop computer's USB ports, whose 2.0 or 3.0 modes can only supply 0.5 A or a maximum of below 1.0 A current. The current invention's USB charger can have a higher output of more than 1.0 Amp up to 12 Amps or more depending on market requirements. Because the USB-charger related product of FIG. 5B only has USB ports 25 and no AC outlets, LED-units, or other electric function device(s) built-in, the AC power input wire may be smaller than would be required if AC outlets or AC devices with higher power requirements were included.

FIG. 5C shows the preferred USB-charger in the form of a round-flat unit which can underlay any existing desktop device and does not need to occupy any additional desktop space. As shown in FIG. 5C, the USB-charger related product only has USB ports 25 without any additional outlets, LED-units, or other electric function device(s) so that the size of the built-in AC power input wire 17 can be minimized.

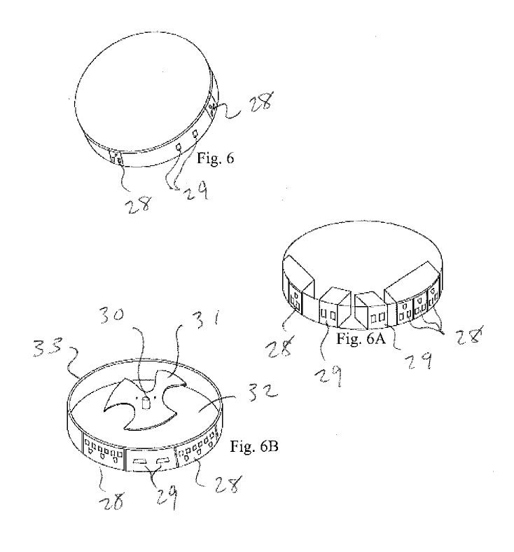

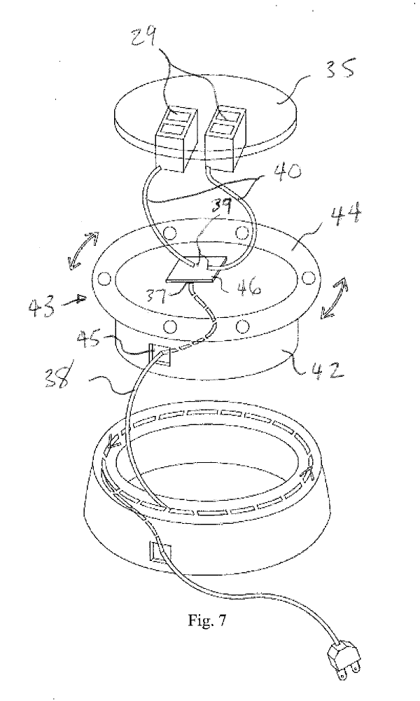

FIG. 6A, shows a geometrically shaped USB charger unit having both USB-ports 29 and built-in AC outlets 28 which need a heavy duty electric cord so the cord's weight will be very heavy to pull on and move the unit in the absence of attachment means to fix the unit at a desired location. The attachment means may include a heavy weight, magnetic means, glue, double sided foam tape, screws, a catch-n-hook fastener, Velcro means, or other market-available skills or materials. The geometrically shaped unit is illustrated as a round flat and thin unit having interior magnetic and heavy weight means to overcome pulling force exerted by the heavy duty AC electric cord, which is required by some safety authorities to be #14 gauge, although the gauge may be variable based on safety requirements for different applications and countries. The preferred round flat and thin unit is designed to underlay any items put on top of it because it is thin, flat, and water resistant, and all receiving USB-ports or outlets ports are on a side with a nice slope so that anything can be put on top and there is no need for any new space on the desktop when using the current invention's unit, which may be (1) a simple USB charger with a small electric wire, (2) a combination of a USB-charger and outlet unit, (3) a combination of a USB-charger, outlet unit, and LED-unit, or (4) a combination of units with more than three functions selected from any electric, electronic, or digital data device or internet devices functions.

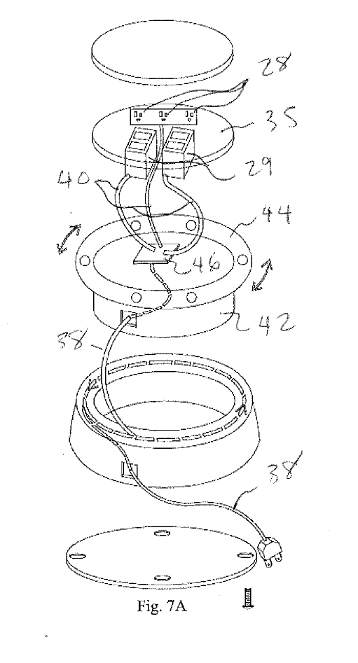

FIGS. 6, 6A, 6B, 6C, 7, and 7A all show USB-charger related products having USB ports 29 and AC outlets 28 only without LED-units or other electric function device(s), and having a built-in AC input power wire which meets the AC outlet power wire requirements and optionally incorporates other one or more additional outlet device components such as surge protection means, remote control means, a master power outlets (that controls all other outlets by causing the other outlets to follow the master), sensor control means, remote control means, current leakage warning means, and auto shut off means to provide the outlets with greater safety and convenient performance.

FIG. 6A, shows an embodiment of a round flat and thin USB-charger related unit which has 4 USB ports 29 and 4 outlets 28 as well as at least one built-in additional function device selected from market-available electric, electronic, digital-data, communications, computer, or other devices. FIG. 6B also shows a preferred space for the USB-charger and outlets' body and a face arrangement for round flat and thin unit (not including the heavy AC electric cord and its plug-means).

FIG. 6B also shows the bottom construction for the bottom wire arrangement means which has a center pole 30 to hold an island-shaped stopper means 31 to prevent the wire falling out from the built-in space, room, or compartment 32 that holds the wire when it is coiled or wrapped around the center pole 30 and which extends to a curved wall 23. In this embodiment, 6 AC outlets 28 and 2 USB-ports 29 are preferably arranged within the bottom of the unit.

FIG. 7 shows a central rotating means to cause wire release or coiling back to the unit, the construction of which includes:

(1) A top cover 35 installed with receiving means that include any desired combination of at least one USB-port 29, outlet, LED-unit, sensor means, motion sensor, remote control means, audio or video related means, digital data-means, internet related means, or other market-available electric or electronic means. (2) At least one of the receiving-means wires 36 from the USB-port 29 and outlet or LED-units is connected to internal circuit-means and/or circuit means having a built-in PCB 46 PCB input-end 37 to connect with an electric power input wire 38. The PCB output-end 39 is connected to the wires 40 from the receiving-means. The circuit means uses the PCB 46 to connect the wires 40 from the receiving-means at the output-end 39 with the power source input wire 38 at the on input-end 37. (3) The AC electric input power wire 38 is coiled or wrapped within the unit housing, for example by a rotatable inner-housing-wall 42 of a rotatable-means 43, and can be released or coiled by rotating a top ring 44 or part of the unit's housing. The preferred twisting-means may be a finger twister, which can have any design such as a pole, a holder, a concave finger holes, ribs, raised bars, or other twisting-means. (4) At least one opening 45 is provided in the rotatable inner housing-wall 42 that contains the PCB 46 with the circuit means for converting input power into appropriate output power current and voltage. The opening 45 will rotate when the rotatable inner housing-wall 42 is rotated and cause the PCB input end's electric power wire 38 to be coiled or released from the opening 45 located on the rotatable inner housing-wall 42. (5) As a result, the power input wire can be easily coiled or released from the power input wire output-end.

FIG. 7A shows further details of the arrangement of FIG. 7

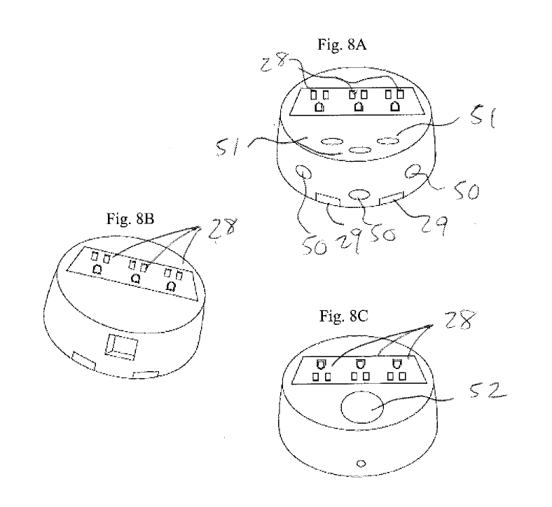

FIGS. 8A, 8B, and 8C show an embodiment which has a built-in wire arrangement means on the base to coil and release a power wire(s) so as to achieve a nice and neat arrangement of the wire from the power source to the desk top and allow the USB-charger unit to be placed at a hand-reachable distance on the desktop for use in charging other electric, electronic, digital-data, image, audio, video, or other available devices from the marketplace without requiring the user to kneel down or bend in order to connect a device with the charger.

FIG. 8A shows a plurality of LED-units 50 for front illumination, and a plurality of LED units 51 for top-facing illumination and that light-transmitting items to be put on top of the LEDs to achieve different light performances. For example, a plastic beverage bottle with different colors can be placed on top of the LEDs to become a colorful lantern, or an ashtray can be used to provide a crystal light performance. The USB-charger can have any geometric shape such as a big round flat and thin shape that allows anything to be put top of it without occupying any extra desk space. The big round flat and thin unit can also have a nice surface finish such as a wooden, metalized, marble, stone, or antique brass finish to make the USB-charger become a very valuable item that people are more willing to put on a desk top. The USB-charger related product of FIG. 8A can have built-in USB-ports 29, outlets 28, and LED-units 50 or 51 only, without other electric function devices and a built-in AC power input wire which meet the outlet AC power wire standard.

As shown in FIG. 8C, the USB-charger product may include a motion sensor or remote control receiver means 52 installed on a front of the desktop USB-charger device to make electric signal contact easier. FIG. 8C shows a USB-charger related product having built-in USB-ports, outlets, LED-units and other electric function devices. The inner housing of the USB-charger products of FIGS. 8A to 8C may also have a built-in spring or retract means and other wire arranging parts and accessories to hold, store, coil, receive, release, pull, twist, extend, fold, or retract a wire by spring, elastic, roller, or rotating means to cause the AC power wire or receiving-end(s) wire to be well arranged for use in consideration of pre-designed requirements, performances, functions, and effects.

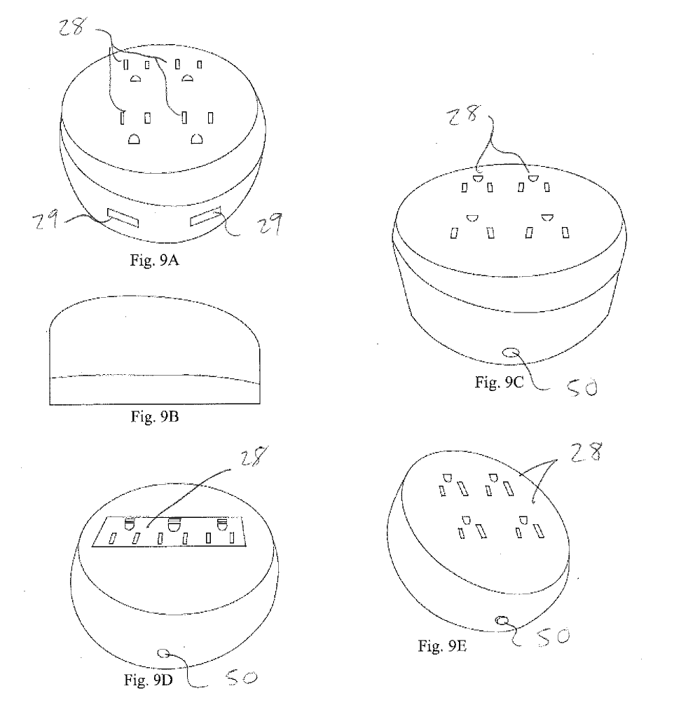

FIGS. 9A, 9B, 9C, 9D, 9E, 10A, 10B, 11A, and 11B also show built-in wire arrangements on a base to coil or release a wire from a USB-charger unit having a desired combination of USB-ports, outlets, LED-units and an optional added function device(s) so that the USB charger unit offers three or more functions including USB and outlet power supply, and the at least one added function.

FIGS. 10A 10B show USB-charger related products having built-in USB-port(s), outlet(s), LED-unit(s) and other electric function device(s) for a total of more than three functions for the USB-charger related product, the said built-in AC power wire which is meet the Outlet AC Power wire standard. Furthermore, the USB charger related products may incorporate other devices 55 such as a motion sensor device, time device, remote control device, Infrared device, LED light device, integrated circuit (IC), control device, sensor device, power fail device, color changing status-indicator devices, controller device, smell device(s), motion device, audio device, video device, cable TV device, Internet device, or other market-available electric or electronic devices. The preferred embodiment may have a master outlet feature 57, outlets having a built-in surge protection circuit, or a built-in retraction or spring means 56 to cause a wire to extend and be received back by elastic force, the wire being arranged on the bottom or within the housing at a desired location, space, room, compartment, gap, or wall.

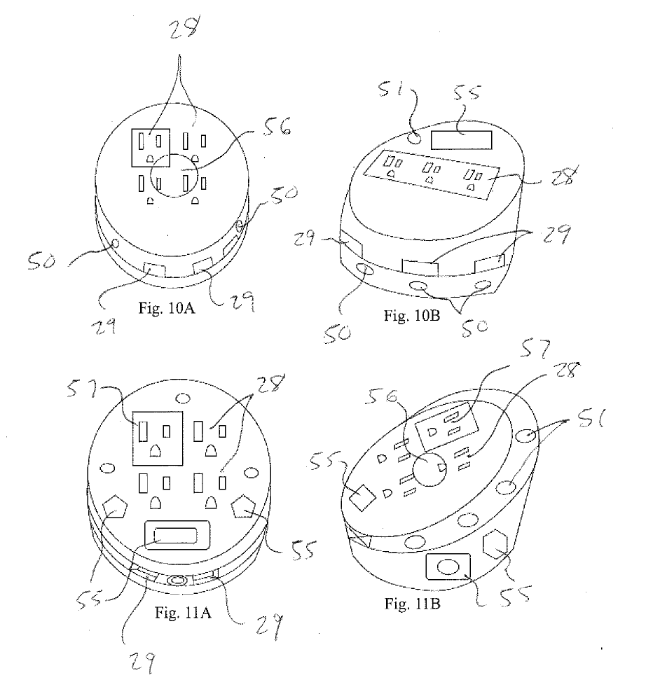

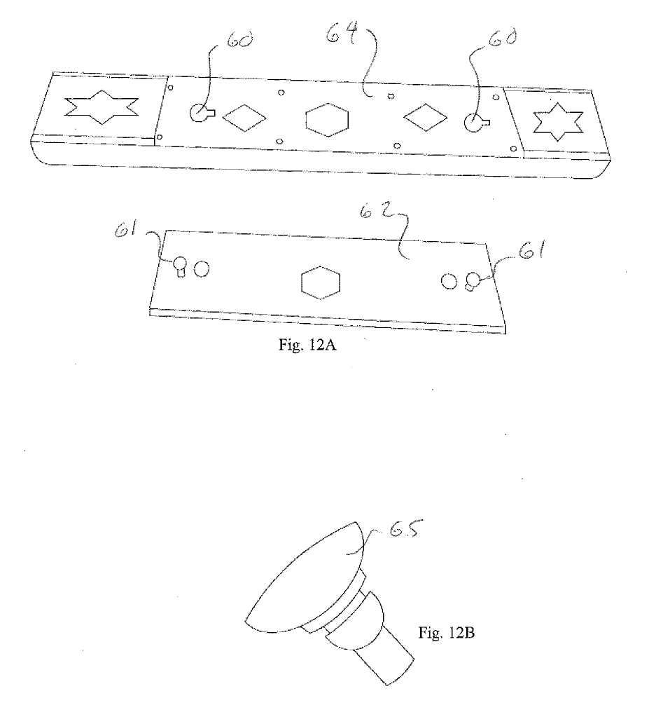

FIGS. 11A and 11B show different combinations of the above-listed added function devices suitable for inclusion in the hand-reachable desk top USB-charger related products of the current invention.

FIG. 12A shows a catch 60 and hook 61 of a holding arrangement that uses screws or double sided glue means for installing a first plate 62 on a surface, with the catch 60 and hook 61 being used to fasten the USB-charger product 64 to the first plate 62, and thereby hold the USB-charger product 64 on the surface.

FIG. 12B shows a suction cup arrangement 65 installed within layers of the USB-charger product's housing to hold the product in position against force applied to the product.

The current invention also has below 24 features:
1. A hand-reachable desk top USB power station has wire arrangement, comprising:
   a USB power station including at least one of USB-port for receiving a male USB-Plug of a USB wire and build the electric delivery between power station and external electric or digital device(s).
   the USB-Plug of the USB wire that is inserted into both power station and external electric device the USB-ports to delivery current.
   At least one current deliver from Power station to the said external device, or-and to supply current-and charge the internal energy storage unit of the external electric or digital device;
   a wire arrangement construction for arranging wires including (1) a USB-wire connected between the power station and other electric or digital device female USB-port, or (2) an AC input wire which connected between USB power station and AC power source,
   The wire arrangement by (a) coiling or (b) wrapping or (c) rolling or (d) pulling the USB wire or-and AC input wire by manual or by spring-assembly to a pole, or groove, or gap, or housing, or bars, or space, or holder within a space of USB power station.
   The wire arrangement construction including a cover or holder or housing space for retaining the USB wire or-and AC input wire in the desired position or location, preferred to select one of a mechanism or manual-skill for winding and retracting the wire,
   wherein the USB power station includes circuitry for converting the AC 110 to 250 Voltage input current-into a DC 3.5 to 15-volt output current of at least 1 Amp.

wherein the hand-reachable desk top USB power station is semi-permanently install or arranged to be situated in a hand-reachable position on a desk top until replace it, the USB power station including attachment kits for holding the USB power station on the desk top.

The attachment kits including at least one of the following: (aa) glue, (bb) screws, (cc) a heavy weight, (dd) a catch and hook fastener, (ee) velcro™, (ff) double-sided foam tape, (gg) a hook and loop fastener, (hh) at least one suction cup, (ii) a magnetic fastener, (j j) a movement-preventer so that the USB power station can be reached by a user to charge the electric or digital device without having to bend over to reach the USB charger.
2. A hand-reachable desk top USB power station has wire arrangement, wherein the USB power station has only USB-ports and no AC outlet, no LED unit, or no other electrical device, and the AC input wire has a gauge of less than or equal to 16.
3. A hand-reachable desk top USB power station has wire arrangement, wherein the USB power station has USB-ports and at least one AC outlet, and wherein the USB power station need 14-gauge wire and group select desired outlet safety or convenience function selected from (1) a surge protection, (2) a remote control function, (3) a master power function, (4) a sensor function, (5) a current leakage warning function, (6) over heat sensor and safety function, and (7) an auto shut off function.
4. A hand-reachable desk top USB power station has wire arrangement, wherein the USB charger device has at least one additional parts or-and system including at least one or more of (a) another USB-port, (b) an AC outlet, (c) a motion or moving detector(s) sensor, (d) a remote control system, (e) IR or RF remote controller, (f) an integrated circuit (IC), (g) a blue-tooth connection, (h) a sensor, (i) a power fail function, (j) a color changing status-indicating system, (k) a smell, (1) a motion, (m) a video, (n) a cable TV, (o) an Internet, (p) a wireless communication to connect Wi-Fi, 3G/4G/5G network, (q) microphone and speaker for talking, (r) LED light emit light out from power station housing, (s) stationary or tools compartment said additional parts or-and system providing at least one its own function for people use during work, study, meeting;
5. A hand-reachable desk top USB power station has wire arrangement, wherein the AC input wire has a gauge sufficient to meet safety requirements for a device having AC outlets.
6. A hand-reachable desk top USB power station has wire arrangement, wherein the wire arrangement includes (1) elastic rolling device, (2) metal has elastic or spring for rolling function, or (3) rotating device, (4) coil device to enable extension and retraction of the USB wire or-and AC input wire by rolling, rotating, coiling, pulling, or twisting.
7. A hand-reachable desk top USB power station has wire arrangement, wherein the USB power station unit has a top surface on which other objects may be positioned during use so as to save desk top space.
8. A hand-reachable desk top USB power station has wire arrangement, wherein the USB power station is included in an extension-cord or power-strip that is attached-on or fixed-on or install-on or tight-on or tie-on or magnetic-on or screw-on or clip-on a desk desired surface to be hand reachable.
9. A hand-reachable desk top USB charger device has wire arrangement, comprising:
   a USB charger including desired number of USB-port(s) for receiving and connecting with a USB-plug of a USB wire connected to an external electric or digital device.
   The said USB-plug of USB wire including at least 2 or more USB-plug that is inserted into the both USB charger device and external electric or digital device USB-port(s) to supply charging current for charging an internal energy storage unit(s) of the external electric or digital device;
   a wire arrangement construction for arranging wire including (1) the USB wire, or (2) an AC input wire for supplying an AC input current from an external power source to the USB charger, by coiling or wrapping the USB wire or-and AC input wire around a pole, or groove, or gap, or space within a space in the USB charger device.
   The wire arrangement construction including a cover or holder or housing space for retaining the USB wire or-and AC input wire in the desired position or location, preferred to select one of a mechanism or manual-skill for winding and retracting the wire.
   wherein the hand-reachable desk top USB charger device is semi-permanently install or arranged to be situated in a hand-reachable position on a desk top until replace it.
10. A hand-reachable desk top USB charger device has wire arrangement, wherein the said desk top device has at least one additional device including at least one or more of (a) another USB-port, (b) an AC outlet device, (c) a motion or moving detector sensor device, (d) a LED displayer time device, (e) a remote control device, (f) IR or RF remote control device, (g) LED light device and light beam emit out from the charger device housing, (h) an integrated circuit (IC), (i) a control or circuitry device, (j) a sensor device, (k) a power fail device, (l) a color charging status-indicating device, (m) a smell device, (n) a motion device, (o) a video device, (p) a cable TV device, (q) an Internet device, (r) a wireless device, (s) a stationary or tool compartment for storage kits device, (t) a speaker and microphone for communication by wired or wireless device , (u) display unit has liquid with element has heat to make decorative miniature items moving by heat or-and liquid chemical reaction; and those said additional device providing at least one its own function.
11. A hand-reachable desk top USB charger device has wire arrangement, wherein the said desk top device is arranged to be situated in a hand-reachable position on a desk top during use, the USB charger device including attachment kits for holding the USB charger device on the desk top, the attachment kits including at least one of the following: (aa) glue, (bb) screws, (cc) a heavy weight, (dd) a catch and hook fastener, (ee) velcro™, (ff) double-sided foam tape, (gg) a hook and loop fastener, (hh) at least one suction cup, (ii) a magnetic fastener, (jj) a movement-preventer so that the USB charger can be reached by a user to charge the electric or digital device without having to bend over to reach the USB charger.
12. A hand-reachable desk top USB power station has wire arrangement, wherein the said desk top device wherein the USB charger includes built-in or connects external transformer AC-to-DC circuitry for converting the AC input 110 to 250 volt current, into a DC 3.5 to 15 volt output current of at least 1 Amp.
13. A hand-reachable desk top USB power station has wire arrangement, wherein the said desk top device wherein the said USB Charger device is install inside of the power-strip, extension cord which has plurality of AC outlets to supply the AC current to other device.
14. A hand-reachable desk top USB power station has wire arrangement, wherein the said desk top device wherein the USB Charger device for power strip or extension cord which install-on or attached-on or tie-on the desk by telephone hook, conventional attached kits, fix kits. Increase weight unit, screws, catcher or magnetic piece.
15. A hand-reachable desk top USB power station has wire arrangement, wherein the said desk top device is extension cord or power strip is permanently install on desk not movable often and non-portable device after installation.
16. A hand-reachable desk top USB power station has wire arrangement, wherein the said desk top device also can install on desk side surface not limited to top surface by proper attach or fix or install kits.
17. A hand-reachable desk top USB power station has wire arrangement, wherein the said desk top device wherein the device has geometric shape and size.
18. A hand-reachable desk top USB power station has wire arrangement, wherein the said desk top device wherein the device also can have powered by the AC-to-DC transformer, adaptor, invertor to supply DC current to the said USB though built-in or outside AC-to-DC or-and DC-to-DC circuit.
19. A hand-reachable desk top USB power station has wire arrangement, wherein the said desk top device wherein the device only has USB charger and other DC powered added device both can powered by outside unit AC-to-DC circuit and inside DC-to-DC circuit to offer the same or-and different working DC voltage function.
20. A hand-reachable desk top USB power station has wire arrangement, wherein the said desk top device wherein the device has USB Charger and other AC powered added device both can use AC input power to supply power to added AC device and inside DC-to-DC circuit to offer USB charger power.
21. A hand-reachable desk top USB power station has wire arrangement, wherein the said desk top device wherein the device has USB charger or-and DC power added device or-and AC power added device with proper outside unit or-and built-in AC-to-DC or more than one DC-to-DC circuit to supply each current for operation.
22. A hand-reachable desk top USB power station has wire arrangement, wherein the said desk top device wherein the device for DC powered added function and USB charger both use DC current with same or different voltage can get power from designed combination of selected from AC-to-DC circuit, more than one DC-to-DC circuit, AC input power, battery, rechargeable battery, solar power, chemical power.
23. A hand-reachable desk top USB power station has wire arrangement, wherein the said desk top device wherein the device said device has outlets which can receiving the any AC plug to power the said AC power electric device.
24. A hand-reachable desk top USB power station has wire arrangement, wherein the said desk top device wherein the device has adaptor or receiving ends to receive outside transformer, adaptor, invertor power to make device is universal worldwide and only need use different countries' input AC voltage transformer, adaptor, invertor for each country.

I claim:

1. A hand-reachable desk top USB power station has wire arrangement, comprising:
a USB power station including at least one of USB-port for receiving a male USB-Plug of a USB wire and build the electric delivery between power station and external electric or digital device(s).
the USB-Plug of the USB wire that is inserted into both power station and external electric device the USB-ports to delivery current.
At least one current deliver from Power station to the said external device, or-and to supply current and charge the internal energy storage unit of the external electric or digital device;
a wire arrangement construction for arranging wires including (1) a USB-wire connected between the power station and other electric or digital device female USB-port, or (2) an AC input wire which connected between USB power station and AC power source,
The wire arrangement by (a) coiling or (b) wrapping or (c) rolling or (d) pulling the USB wire or-and AC input wire by manual or by spring-assembly to a pole, or groove, or gap, or housing, or bars, or space, or holder within a space of USB power station.
The wire arrangement construction including a cover or holder or housing space for retaining the USB wire or-and AC input wire in the desired position or location, preferred to select one of a mechanism or manual-skill for winding and retracting the wire,
wherein the USB power station includes circuitry for converting the AC 110 to 250 Voltage input current into a DC 3.5 to 15-volt output current of at least 1 Amp.
wherein the hand-reachable desk top USB power station is semi-permanently install or arranged to be situated in a hand-reachable position on a desk top until replace it, the USB power station including attachment kits for holding the USB power station on the desk top.
The attachment kits including at least one of the following: (aa) glue, (bb) screws, (cc) a heavy weight, (dd) a catch and hook fastener, (ee) velcro™, (ff) double-sided foam tape, (gg) a hook and loop fastener, (hh) at least one suction cup, (ii) a magnetic fastener, (jj) a movement-preventer so that the USB power station can be reached by a user to charge the electric or digital device without having to bend over to reach the USB charger.

2. A hand-reachable desk top USB power station has wire arrangement as claimed in claim 1, wherein the USB power station has only USB-ports and no AC outlet, no LED unit, or no other electrical device, and the AC input wire has a gauge of less than or equal to 16.

3. A hand-reachable desk top USB power station has wire arrangement as claimed in claim 1, wherein the USB power station has USB-ports and at least one AC outlet, and wherein the USB power station need 14 gauge wire and group select desired outlet safety or convenience function selected from (1) a surge protection, (2) a remote control function, (3) a master power function, (4) a sensor function, (5) a current leakage warning function, (6) over heat sensor and safety function, and (7) an auto shut off function.

4. A hand-reachable desk top USB power station has wire arrangement as claimed in claim 1, wherein the USB charger device has at least one additional parts or-and system including at least one or more of (a) another USB-port, (b) an AC outlet, (c) a motion or moving detector(s) sensor, (d) a remote control system, (e) IR or RF remote controller, (f) an integrated circuit (IC), (g) a blue-tooth connection, (h) a sensor, (i) a power fail function, (j) a color changing status-indicating system, (k) a smell, (l) a motion, (m) a video, (n) a cable TV, (o) an Internet, (p) a wireless communication to connect Wi-Fi, 3G/4G/5G network, (q) microphone and speaker for talking, (r) LED light emit light out from power station housing, (s) stationary or tools compartment said additional parts or-and system providing at least one its own function for people use during work, study, meeting;

5. A hand-reachable desk top USB power station has wire arrangement as claimed in claim 1, wherein the AC input wire has a gauge sufficient to meet safety requirements for a device having AC outlets.

6. A hand-reachable desk top USB power station has wire arrangement as claimed in claim 1, wherein the wire arrangement includes (1) elastic rolling device, (2) metal has elastic or spring for rolling function, or (3) rotating device, (4) coil device to enable extension and retraction of the USB wire or-and AC input wire by rolling, rotating, coiling, pulling, or twisting.

7. A hand-reachable desk top USB power station has wire arrangement as claimed in claim 1, wherein the USB power station unit has a top surface on which other objects may be positioned during use so as to save desk top space.

8. A hand-reachable desk top USB power station has wire arrangement as claimed in claim 1, wherein the USB power station is included in an extension-cord or power-strip that is attached-on or fixed-on or install-on or tight-on or tie-on or magnetic-on or screw-on or clip-on a desk desired surface to be hand reachable.

9. A hand-reachable desk top USB charger device has wire arrangement, comprising:
a USB charger including desired number of USB-port(s) for receiving and connecting with a USB-plug of a USB wire connected to an external electric or digital device.
The said USB-plug of USB wire including at least 2 or more USB-plug that is inserted into the both USB charger device and external electric or digital device USB-port(s) to supply charging current for charging an internal energy storage unit(s) of the external electric or digital device;
a wire arrangement construction for arranging wire including (1) the USB wire, or (2) an AC input wire for supplying an AC input current from an external power source to the USB charger, by coiling or wrapping the USB wire or-and AC input wire around a pole, or groove, or gap, or space within a space in the USB charger device.
The wire arrangement construction including a cover or holder or housing space for retaining the USB wire or-and AC input wire in the desired position or location, preferred to select one of a mechanism or manual-skill for winding and retracting the wire.
wherein the hand-reachable desk top USB charger device is semi-permanently install or arranged to be situated in a hand-reachable position on a desk top until replace it.

10. A hand-reachable desk top USB charger device has wire arrangement as claimed in claim 9, wherein the said desk top device has at least one additional device including at least one or more of (a) another USB-port, (b) an AC outlet device, (c) a motion or moving detector sensor device, (d) a LED displayer time device, (e) a remote control device, (f) IR or RF remote control device, (g) LED light device and light beam emit out from the charger device housing, (h) an integrated circuit (IC), (i) a control or circuitry device, (j) a sensor device, (k) a power fail device, (l) a color charging status-indicating device, (m) a smell device, (n) a motion device, (o) a video device, (p) a cable TV device, (q) an Internet device, (r) a wireless device, (s) a stationary or tool compartment for storage kits device, (t) a speaker and microphone for communication by wired or wireless device , (u) display unit has liquid with element has heat to make decorative miniature items moving by heat or-and liquid chemical reaction; and those said additional device providing at least one its own function.

11. A hand-reachable desk top USB charger device has wire arrangement as claimed in claim 9, wherein the said desk top device is arranged to be situated in a hand-reachable position on a desk top during use, the USB charger device including attachment kits for holding the USB charger device on the desk top, the attachment kits including at least one of the following: (aa) glue, (bb) screws, (cc) a heavy weight, (dd) a catch and hook fastener, (ee) velcro™, (ff) double-sided foam tape, (gg) a hook and loop fastener, (hh) at least one suction cup, (ii) a magnetic fastener, (jj) a movement-preventer so that the USB charger can be reached by a user to charge the electric or digital device without having to bend over to reach the USB charger.

12. A hand-reachable desk top USB power station has wire arrangement as claimed in claim 9, wherein the said desk top device wherein the USB charger includes built-in or connects external transformer AC-to-DC circuitry for converting the AC input 110 to 250 volt current, into a DC 3.5 to 15 volt output current of at least 1 Amp.

13. A hand-reachable desk top USB power station has wire arrangement as claimed in claim 9, wherein the said desk top device wherein the said USB Charger device is install inside of the power-strip, extension cord which has plurality of AC outlets to supply the AC current to other device.

14. A hand-reachable desk top USB power station has wire arrangement as claimed in claim 13, wherein the said desk top device wherein the USB Charger device for power strip or extension cord which install-on or attached-on or tie-on the desk by telephone hook, conventional attached kits, fix kits. Increase weight unit, screws, catcher or magnetic piece.

15. A hand-reachable desk top USB power station has wire arrangement as claimed in claim 13, wherein the said desk top device is extension cord or power strip is permanently install on desk not movable often and non-portable device after installation.

16. A hand-reachable desk top USB power station has wire arrangement as claimed in claim 13, wherein the said desk top device also can install on desk side surface not limited to top surface by proper attach or fix or install kits.

17. A hand-reachable desk top USB power station has wire arrangement as claimed in claim 9, wherein the said desk top device wherein the device has geometric shape and size.

18. A hand-reachable desk top USB power station has wire arrangement as claimed in claim 9, wherein the said desk top device wherein the device also can power by the AC-to-DC transformer, adaptor, invertor to supply DC current to the said USB though built-in or outside AC-to-DC or-and DC-to-DC circuit.

19. A hand-reachable desk top USB power station has wire arrangement as claimed in claim 9, wherein the said desk top device wherein the device only has USB charger and other DC powered added device both can powered by outside unit AC-to-DC circuit and inside DC-to-DC circuit to offer the same or-and different working DC voltage function.

20. A hand-reachable desk top USB power station has wire arrangement as claimed in claim 9, wherein the said desk top device wherein the device has USB Charger and other AC powered added device both can use AC input power to supply power to added AC device and inside DC-to-DC circuit to offer USB charger power.

21. A hand-reachable desk top USB power station has wire arrangement as claimed in claim 9, wherein the said desk top device wherein the device has USB charger or-and DC power added device or-and AC power added device with proper outside unit or-and built-in AC-to-DC or more than one DC-to-DC circuit to supply each current for operation.

22. A hand-reachable desk top USB power station has wire arrangement as claimed in claim 9, wherein the said desk top device wherein the device for DC powered added function and USB charger both use DC current with same or different voltage can get power from designed combination of selected from AC-to-DC circuit, more than one DC-to-DC circuit, AC input power, battery, rechargeable battery, solar power, chemical power.

23. A hand-reachable desk top USB power station has wire arrangement as claimed in claim 9, wherein the said desk top device wherein the device said device has outlets which can receiving the any AC plug to power the said AC power electric device.

24. A hand-reachable desk top USB power station has wire arrangement as claimed in claim 9, wherein the said desk top device wherein the device has adaptor or receiving ends to receive outside transformer, adaptor, invertor power to make device is universal worldwide and only need use different countries' input AC voltage transformer, adaptor, invertor for each country.
